(19) United States
(12) Patent Application Publication
(10) Pub. No.: US 2019/0386601 A1
(43) Pub. Date: Dec. 19, 2019

(54) SYSTEMS AND APPARATUSES FOR PRECIPITATION MANAGEMENT IN SOLAR ASSEMBLIES

(71) Applicant: SUNPOWER CORPORATION, San Jose, CA (US)

(72) Inventors: Alexander F. KELLER, Boston, MA (US); Brian CUFF, Irvington, NY (US); Francois ATTAL, Brooklyn, NY (US); Stephen A. HOPKINS, Brooklyn, NY (US)

(73) Assignee: SUNPOWER CORPORATION, San Jose, CA (US)

(21) Appl. No.: 16/440,224

(22) Filed: Jun. 13, 2019

Related U.S. Application Data
(60) Provisional application No. 62/684,501, filed on Jun. 13, 2018.

(51) Int. Cl. H02S 20/23; H02S 30/10; E04H 6/02

(52) U.S. Cl. CPC H02S 20/23; E04H 6/025; H02S 30/10

(57) ABSTRACT

A solar assembly includes a single-slope crossbeam, a plurality of clip angle brackets, and a plurality of photovoltaic (PV) modules. Each PV module is supported by at least two of the plurality of clip angle brackets, and a height of the plurality of angle brackets differ from each other in order to allow the PV modules to be shingled.

### CROSS-REFERENCE TO RELATED APPLICATIONS

This application claims the benefit of provisional U.S. Application No. 62/684,501, filed Jun. 13, 2018, the entire contents of which are incorporated herein by reference.

### BACKGROUND

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Solar assembly structures (e.g. Single tilt carports, Dual tilt carports, etc.) can be very costly to fabricate, install and maintain. Furthermore, efficient and low cost water and snow management can be challenging. In particular, there are challenges to produce efficient solar assemblies elevated to protect a location underneath the solar assembly from rain or snow without leaking. In order for solar assembly structure (e.g. dual tilt carports) to be more viable, efficient, and functional, there needs to be a new design strategy that addresses these challenges.

### SUMMARY

According to aspects of the disclosed subject matter, a solar assembly structure (e.g. carport) includes a single slope crossbeam, a plurality of clip angle brackets, and a plurality of solar or photovoltaic (PV) modules, each PV module being supported by at least two clip angle brackets.

According to aspects of the disclosed subject matter, the plurality of clip angle brackets are configured to create a single tilt structure supporting a plurality of shingled PV modules, and wherein the shingled PV modules are configured to direct precipitation toward a gutter.

According to aspects of the disclosed subject matter, the plurality of clip angle brackets are configured to create a dual tilt structure.

According to aspects of the disclosed subject matter, a first slope of the dual tilt structure includes a predetermined number of shingled PV modules, the shingled PV modules being configured to direct precipitation toward a gutter separating the first slope of the dual tilt structure with a second slope of the dual tilt structure.

According to aspects of the disclosed subject matter, the second slope of the dual tilt structure includes a predetermined number of PV modules tilted at an angle configured to face the first slope of the dual tilt structure.

According to aspects of the disclosed subject matter, the predetermined number of PV modules of the second slope are shingled when there is more than one PV module in the second slope.

According to aspects of the disclosed subject matter, the plurality of clip angle brackets have different heights in order to create the dual tilt structure.

According to aspects of the disclosed subject matter, downhill clip angle brackets are higher than uphill clip angle brackets.

According to aspects of the disclosed subject matter, the solar assembly further includes a plurality of purlins configured to support the plurality of PV modules, the plurality of purlins being attached to the single-slope crossbeam via the plurality of clip angle brackets.

According to aspects of the disclosed subject matter a solar assembly includes a support structure, a plurality of solar modules, each solar module being supported by the support structure, and a plurality of clip angle brackets configured to attach the plurality of solar modules to the support structure. The plurality of clip angle brackets are further configured to create an overlap between a first solar module and a second solar module, the second solar module being adjacent to the first solar module.

According to aspects of the disclosed subject matter, the solar assembly further includes a drip edge disposed on the first solar module and configured to prevent precipitation from entering a gap between the first solar module and the second solar module.

According to aspects of the disclosed subject matter, the drip edge is integrally formed on the first solar module.

According to aspects of the disclosed subject matter, the solar assembly further includes a flashing disposed on the first solar module and configured to prevent precipitation from entering a gap between the first solar module and the second solar module.

According to aspects of the disclosed subject matter, the flashing further attaches to the second solar module.

According to aspects of the disclosed subject matter, the flashing is flexible.

According to aspects of the disclosed subject matter, the solar assembly further includes a gutter disposed between two rows of solar modules and configured to guide precipitation received to an end thereof.

According to aspects of the disclosed subject matter, the solar assembly further includes at least one downspout configured to guide the precipitation from the gutter to a ground surface.

According to aspects of the disclosed subject matter, the two rows of solar modules are angled towards the gutter.

According to aspects of the disclosed subject matter, the solar assembly further includes gaskets configured to fill gaps between abutting PV module ends that do not overlap.

According to aspects of the disclosed subject matter, the support structure includes a dual-tilt support beam.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates an exemplary overview of a solar assembly (e.g. carport) including shingled photovoltaic modules according to one or more aspects of the disclosed subject matter;

FIG. 2 is an exemplary view of another solar assembly including shingled photovoltaic modules according to one or more aspects of the disclosed subject matter;

FIG. 3 is an expanded exemplary view of the other solar assembly including shingled photovoltaic modules according to one or more aspects of the disclosed subject matter;

FIG. 4A illustrates an exemplary photovoltaic modules support structure according to one or more aspects of the disclosed subject matter;

FIG. 4B illustrates a close up view of an exemplary overlap structure of photovoltaic modules according to one or more aspects of the disclosed subject matter;

FIG. 4C illustrates a close up view of an exemplary overlap structure of photovoltaic modules according to one or more aspects of the disclosed subject matter;

FIG. 4D illustrates a close up view of an exemplary overlap structure of photovoltaic modules according to one or more aspects of the disclosed subject matter;

FIG. 5 illustrates exemplary water management features for a carport according to one or more aspects of the disclosed subject matter;

FIG. 6 illustrates a perspective view of an exemplary carport according to one or more aspects of the disclosed subject matter, and

FIG. 7 illustrates a perspective view of an exemplary carport according to one or more aspects of the disclosed subject matter.

### DETAILED DESCRIPTION

The description set forth below in connection with the appended drawings is intended as a description of various embodiments of the disclosed subject matter and is not necessarily intended to represent the only embodiment(s). In certain instances, the description includes specific details for the purpose of providing an understanding of the disclosed subject matter. However, it will be apparent to those skilled in the art that embodiments may be practiced without these specific details. In some instances, well-known structures and components may be shown in block diagram form in order to avoid obscuring the concepts of the disclosed subject matter.

Reference throughout the specification to “one embodiment” or “an embodiment” means that a particular feature, structure, characteristic, operation, or function described in connection with an embodiment is included in at least one embodiment of the disclosed subject matter. Thus, any appearance of the phrases “in one embodiment” or “in an embodiment” in the specification is not necessarily referring to the same embodiment. Further, the particular features, structures, characteristics, operations, or functions may be combined in any suitable manner in one or more embodiments. Further, it is intended that embodiments of the disclosed subject matter can and do cover modifications and variations of the described embodiments.

It must be noted that, as used in the specification and the appended claims, the singular forms “a,” “an,” and “the” include plural referents unless the context clearly dictates otherwise. That is, unless clearly specified otherwise, as used herein the words “a” and “an” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein, merely describe points of reference and do not necessarily limit embodiments of the disclosed subject matter to any particular orientation or configuration. Furthermore, terms such as “first,” “second,” “third,” etc., merely identify one of a number of portions, components, points of reference, operations and/or functions as described herein, and likewise do not necessarily limit embodiments of the disclosed subject matter to any particular configuration or orientation.

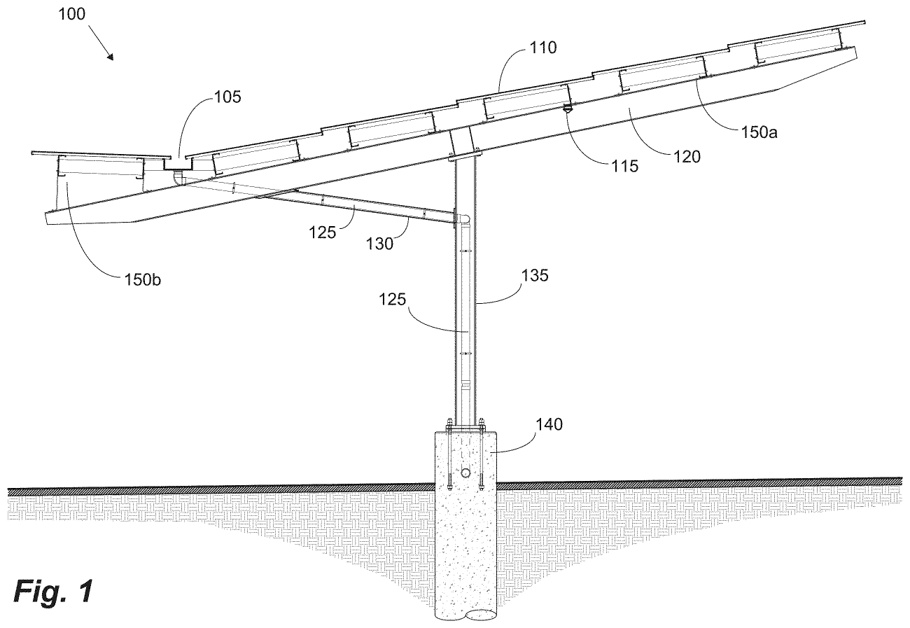

Referring now to the drawings, wherein like reference numerals designate identical or corresponding parts throughout the several views, FIG. 1 illustrates an exemplary overview of a solar assembly (e.g. carport) 100 according to one or more aspects of the disclosed subject matter. The carport 100 includes water management features where the solar or photovoltaic (PV) modules shingle each other to avoid using costly materials and installation techniques (e.g., installing mini gutters between each PV module are an added expense). Shingled modules can be employed with any desirable underlying support structure (e.g., single tilt, horizontal, dual tilt, and so on). In an exemplary embodiment, the water management features in FIG. 1 include a dual tilt canopy where the inverse angle is created by propping up the attachment brackets on a single sloping crossbeam rather than complicated fabrication methods to create the dual tilt functionality using crossbeams of two different angles. The carport 100 can also include shingled photovoltaic modules as further described herein.

There has been a long standing need for protective structures (e.g. carports) in geographic areas where snow and water management pose significant challenges. For purposes of description, a dual tilt carport will be used as an example, however it should be appreciated that the invention can be applied to a wide range of solar assemblies including but not limited to fixed tilt solar installations, single tilt solar installations or carports, dual tilt solar installations or carports, and so on. In one example, example, owners of parking lots may want or need to provide their customers and tenants with protection from the snow and rain. The nature of the shingled module and/or dual tilt design allows snow, rain, hail, ice, precipitation, etc. to accumulate and remain on top of the canopy (e.g., prevents snow, ice, etc. from sliding off the canopy and causing damage and/or injury) while at the same time provides a way for liquid to accumulate in the center of the canopy where a system of gutters bring the water back down to the parking lot surface. However, the dual tilt carport has traditionally been costly to fabricate, install, and maintain. For example, traditional dual tilt carports require more parts associated with this design including mini gutters, main gutters, downspouts, gaskets, metal decking, and complicated fabrication methods to achieve the two different angles of the dual tilt. Additionally, traditional dual tilt design is more expensive than a single tilt carport without water or snow management. It also yields less energy production from the solar panels because half of the panels face a direction that is less than ideal from a solar exposure standpoint. Accordingly, the carport 100 can provide a more cost effective solution that utilizes less parts, is easier to install and maintain, and generates more energy production.

It should be appreciated that the shingled modules can provide an overlap structure where a first solar module overlaps a portion of a second solar module, the second solar module being adjacent to the first solar module. The shingled structure can be applied to various solar assembly structures including fixed tilt solar installations, single tilt solar installations or carports, dual tilt solar installations or carports, and so on.

More specifically, the carport 100 can include a gutter 105, a plurality of PV modules 110, one or more light fixtures 115, a crossbeam 120, a downspout 125, a brace arm 130, a column 135, and a pier 140. As illustrated in FIG. 1, and as described in greater detail below, each of the PV modules is attached to the crossbeam 120, directly or indirectly, by a clip angle bracket, such as clip angle brackets 150a and 150b. The clip angle brackets 150a all have the same, or similar, dimensions. The clip angle bracket 150b has longer legs 151, 152 than those of the clip angle brackets 150a in order to change a tilt angle of its corresponding PV module 110 and form the dual tilt structure of the carport 100.

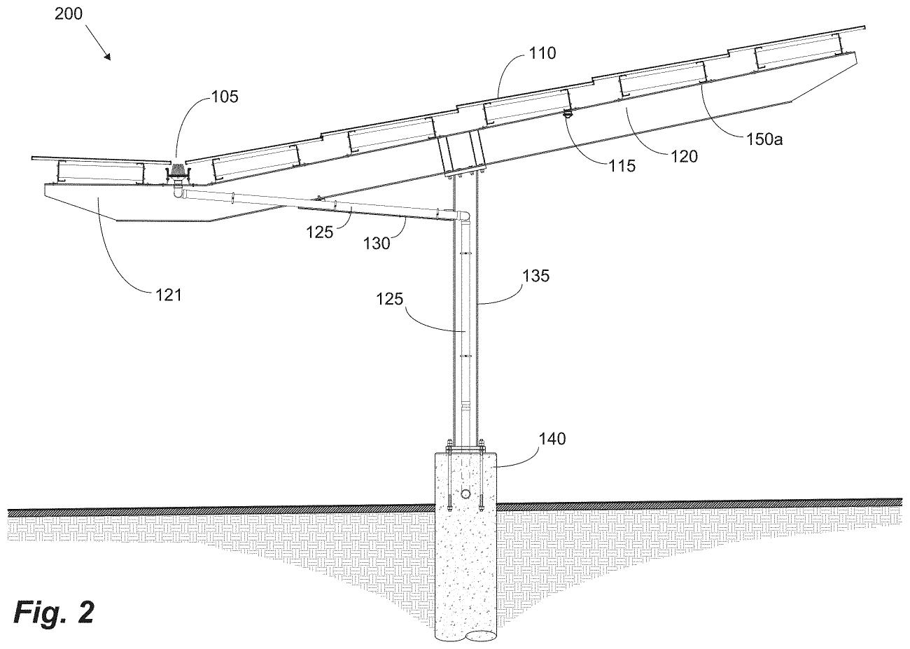

FIG. 2 illustrates another carport 200 according to exemplary aspects of the disclosed subject matter. The downspout 125, the brace arm 130, the column 135, the pier 140, and the plurality of PV modules 110 illustrated in FIG. 2 are substantially the same as those of like reference numbers illustrated in FIG. 1. Therefore, no further description of these components is provided for the sake of brevity.

The crossbeam 120 of the carport 200 includes a section 121 that forms an angle with respect to the rest of the crossbeam that is different from 180°. This results in a crossbeam 120 that is a dual-tilt crossbeam. FIG. 2 illustrates the section 121 as being substantially parallel to the ground surface. However, the section 121 may also be also form an angle with respect to the remainder of the crossbeam 120 such that the section 121 tilts upward, or downward. The section 121 may also be any percentage of the length of the crossbeam 120 without limitation.

The clip angle brackets 150a in FIG. 2 may all be of similar height with sufficient variation in the heights thereof to permit shingling of the PV modules. Since the section 121 creates an angle with respect to the remainder of the crossbeam 120, the clip angle brackets 150a of the PV module 110 disposed on the section 121 does not require a significantly large disparity in the lengths of the brackets in order to form a dual-tilt structure. Instead the dual-tilt structure is generated by the crossbeam 120 itself. Of course, nothing precludes the angle brackets 150a of the PV module 110 disposed on the section 121 may also have a significant disparity in length to augment, or lessen, the angle imparted by the section 121. Numerous other variations on the angle of the section 121 and the lengths of the angle brackets of the PV module 110 disposed on the section 121 are also possible without departing from the scope of the disclosed subject matter.

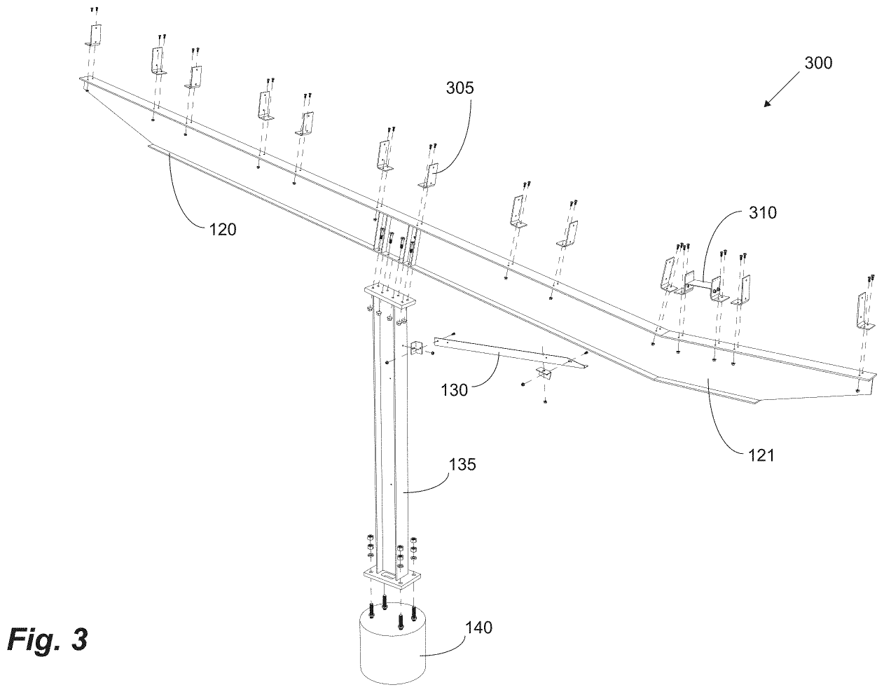

FIG. 3 is an expanded view of the carport 200 of FIG. 2. In FIG. 3 assembly of the carport 200 is illustrated. For example, the clip angle brackets 305, the crossbeam 120, the column 135, the brace 130 are shown as being bolted together with bolts, and bolted to the pier 140 with bolts. However, other fasteners can also be used, such as rivets. The components of the carport 200 may also be welded together. Thus, the specific fasteners used to assemble the carport 200 are not limiting upon the disclosed subject matter. Furthermore, different shapes and structure of the column, pier 140 and/or brace can be employed without departing from the scope of the disclosed subject matter.

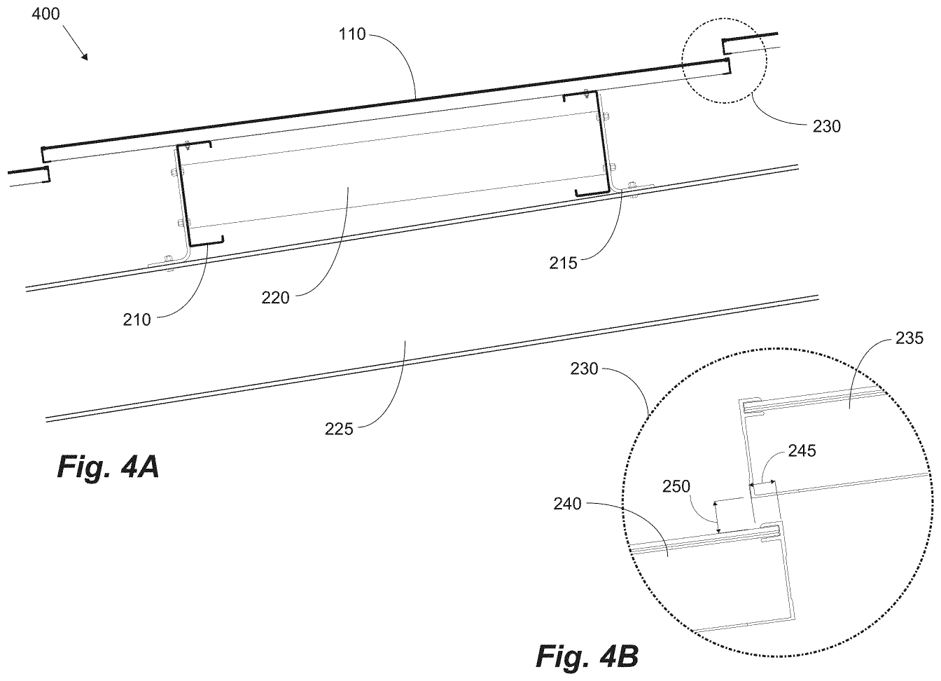

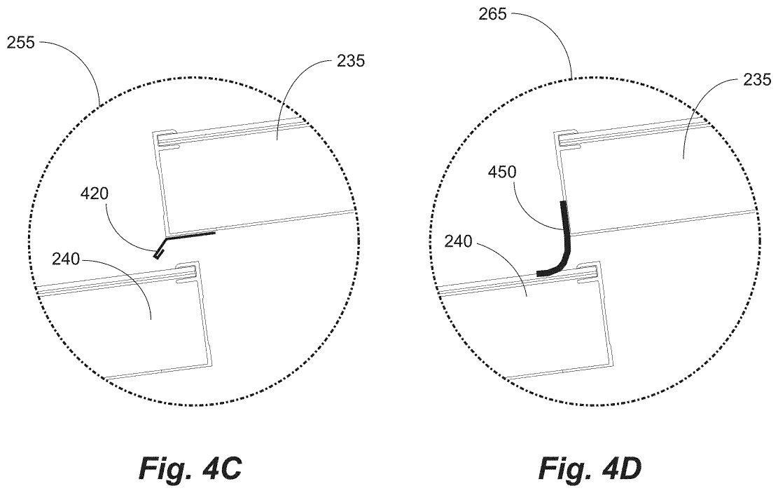

FIG. 4A illustrates an exemplary photovoltaic module (PV) support structure 400 according to one or more aspects of the disclosed subject matter. The PV support structure 400 includes at least one purlin 210 connected to the PV module 110, at least one clip angle bracket 215 connect to each purlin 210 and to the crossbeam 120, and blocking 220 between the purlins 210. Additionally, FIG. 4A illustrates an overlap structure 230.

The shingled configuration of the PV modules 110 are achieved by adjusting the height of the two attachment brackets (e.g., clip angle bracket 215) that hold the PV module 110 to the structure (e.g., crossbeam 120) of the carport 100 (or the carport 200). One of the two clip angle brackets 215 supporting the PV module 110 can be an uphill clip angle which is lower in height than a downhill clip angle. The attachment point of the uphill clip angle is higher on the crossbeam 120 than the downhill attachment bracket. Additionally, to achieve the overlap configuration of the PV modules 110, the slope of the crossbeam 120 is approximately 2 degrees steeper than the slope of the PV module 110, for example. Of course, other slopes are possible without departing from the scope of the present disclosure. The combination of the varying heights of the clip angle brackets 215 mounted on top of the steeper crossbeam creates a condition where the lower edge of the PV module 110 is slightly higher than the upper edge of the next downhill module. Additionally, the adjacent lower module is slightly under the footprint of the adjacent upper module. These two factors prevent water from falling through the joints between the upper panel and the lower panel in a similar way to how a shingled roof works.

The above described structure causes the PV modules 110 to be shingled such that a PV module 110 can overlap with an adjacent lower PV module 110. This way water can travel along and down the surface of the PV modules 110 to the gutter 105 without any significant leakage between PV modules 110. The gutter 105is at the valley of the carport 100 and catches the water shed by the PV modules 110, and the downspout 125 guides the water down to the surface of, for example, a parking lot, or other surface covered by the carport 100.

The dual tilt function of the carport (two opposing PV module angles that create a “V” profile) is formed by alternating the heights of the attachment brackets of the most downhill PV module. The most downhill clip angle bracket 215 is significantly higher than the uphill bracket of this PV module. This allows the lower edge of the most downhill PV module 110 to be higher than the lower edge when mounted to the crossbeam 120. Thus the most downhill PV module slopes in the opposite direction of the crossbeam 120.

Dual tilt carport can be 6 modules wide with half of the modules typically sloping to one angle and the other half sloping in an opposing angle to create the “V” profile. However, when a parking lot is oriented in a way where the parking stall striping yields a southern facing carport, the dual tilt design is not as efficient from an energy standpoint compared to a single sloping carport because only half of the modules are oriented in an effective angle towards the sun. The carport 100 solves this problem because in a 6 module design, 5 modules of the width of the carport can face south (instead of 3 in commonly found dual tilt carports). This can be achieved because the two angles of the carport are decoupled with the angle of the crossbeam using the clip angle brackets 215. From a structural standpoint, this imbalance of modules sloped in one direction compared to the one module sloped in the opposing angle does not create an unstable structure, which is in contrast to typical dual tilt carports which need this balance because the two angles of the dual tilt are achieved by fabricating the crossbeam in a way that matches the required tilt angles. The structure would be unstable and inefficient if this balance did not occur.

It should be appreciated that the dual tilt design with the single crossbeam can be achieved with various combinations of how many panels are tilted in one of the two tilt angles in the dual tilt design. For example, FIG. 1 shows 5 panels facing one direction at a 10 degree tilt angle and one panel facing a direction opposite the 5 panels at a 2 degree tilt angle. However, the dual tilt could be 4 and 2, 3 and 3, etc. Additionally, more (e.g., 7 total panels) or less (e.g., 4 total panels) could be used. Further, the tilt angles of the dual tilt design can also be customized based on geographic location, parking lot orientation, anticipated amount of precipitation, and the like. It should be appreciated that the tilt of the positive angle (e.g., the side with 5 panels in FIG. 1) can range from 2-15 degrees, and the tilt of the negative angle (e.g., the side with 1 panel in FIG. 1) can range from 1-5 degrees, for example. In some implementations, shingled PV modules can be supported by a substantially horizontal support structure (e.g. zero to 2 degrees tilt).

Because the clip angle brackets can be used to set the PV modules to various heights, the slope of the crossbeam or support structure can be flat and level and the clip angles can adjust in height to create the desired angle of the PV modules, for example. In other words, a flat horizontal system could be installed because the height of the clip angles can be adjusted such that they would create the slope of the solar panels rather than the support structure. This can allow for increased flexibility in the design of the support structure.

FIG. 4B illustrates a close up view of an exemplary overlap structure 230 of photovoltaic modules 235 and 240 according to one or more aspects of the disclosed subject matter. The overlap structure 230 can be an open joint structure which includes an upper PV module 235 and a lower PV module 240 such that the upper PV module 235 overlaps the lower PV module 240 by a first predetermined distance 245 (e.g., ½ inch). Additionally, the upper PV module 235 can be positioned above the lower PV module 240 by a second predetermined distance 250 (e.g., ½ inch). For example, the first predetermined distance 245 and the second predetermined distance 250 can be substantially the same distance. Generally, the overlap structure 230 can be configured to allow precipitation to travel down the PV modules toward a gutter (e.g., gutter 105). It should be appreciated that various first and second predetermined distances 245, 250 could be contemplated to prevent precipitation from falling through the gap in overlap structure 230 while also maximizing PV module area to maximize the energy able to be generated by the PV module.

FIG. 4C illustrates a close up view of an exemplary overlap structure 255 of photovoltaic modules according to one or more aspects of the disclosed subject matter. The overlap between two PV modules in FIG. 4B is an open overlap, or joint, because there is nothing sealing the gap between the two PV modules. This may allow precipitation to work its way between the two PV modules. To prevent precipitation from entering through the gap between PV modules, FIG. 4C illustrates an overlap structure 255 that includes a drip edge 420 attached to the upper PV module 235. The drip edge 420 guides precipitation from the upper PV module 235 to the lower PV module 240 to discourage the precipitation from entering the gap therebetween. As can be appreciated the drip edge 420 may be formed from materials such as plastic, aluminum, metal, lead, stainless steel, and the like, and may be an integral part of the PV module 235 or may be affixed to the PV module 235 using adhesives, welding, bolts, screws, or any combination thereof.

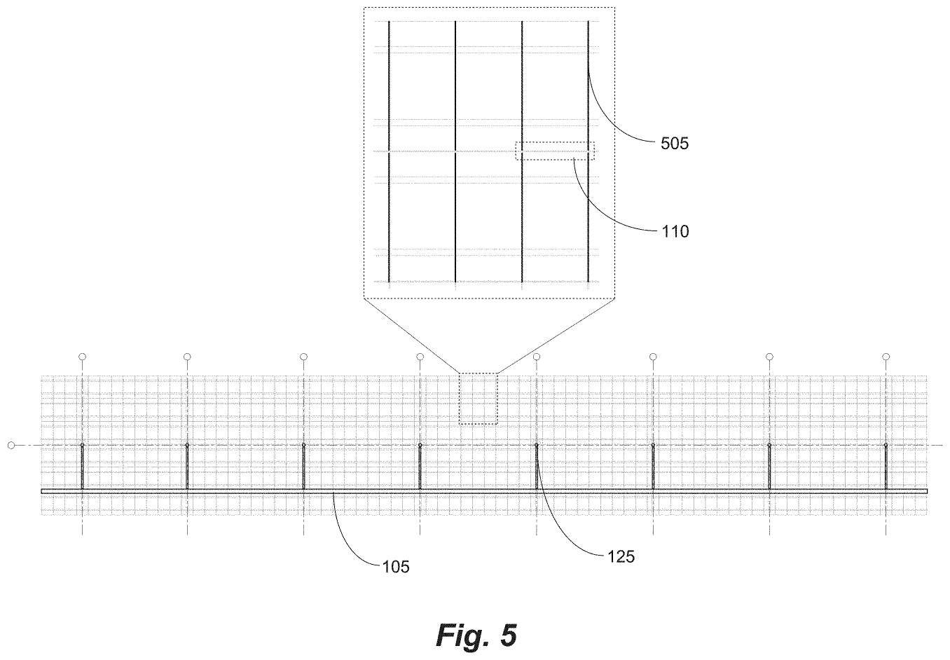

FIG. 4D illustrates a close up view of an exemplary overlap structure 265 of photovoltaic modules according to one or more aspects of the disclosed subject matter. The overlap structure 265 includes flashing 450 attached to the upper PV module 235 and the lower PV module 240 to discourage precipitation from entering the gap between the two PV modules. As can be appreciated, the flashing 450 may be made of a flexible material such as plastic or foam, or may be made of a soft metal such as lead. Other materials can also be used for the flashing 450 without departing from the scope of this disclosure. FIG. 5 illustrates exemplary water management features for a carport according to one or more aspects of the disclosed subject matter. For example, rubber gaskets 505 may be placed between each shingled column of PV modules. Alternatively, or additionally, each column of PV modules may be shingled with an adjacent column of PV modules in addition to each PV module in the column of PV modules being shingled as illustrated in FIG. 1. FIG. 5 also illustrates gutters 105 and a plurality of downspouts 125 that remove precipitation from the carport.

The carport structures disclosed herein can be deployed to any desirable site or surface with any desirable support component without departing from the scope of the present disclosure. In one implementation, a carport can be provided on a ground surface, for example a parking lot or field. In another example a carport structure can be deployed to an above ground surface, for example on a top level of a multi-level parking garage or building.

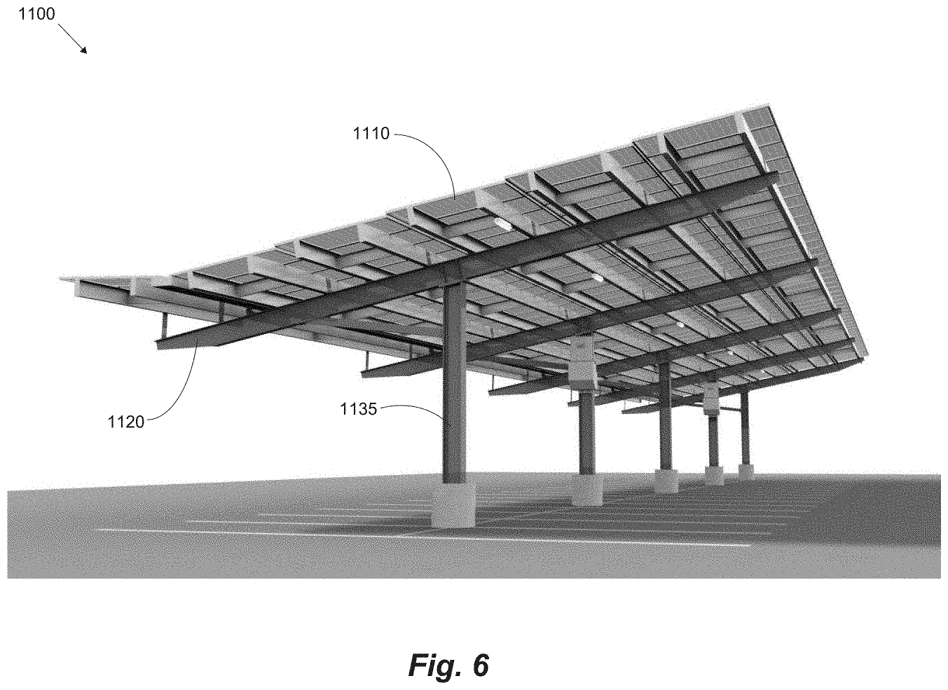

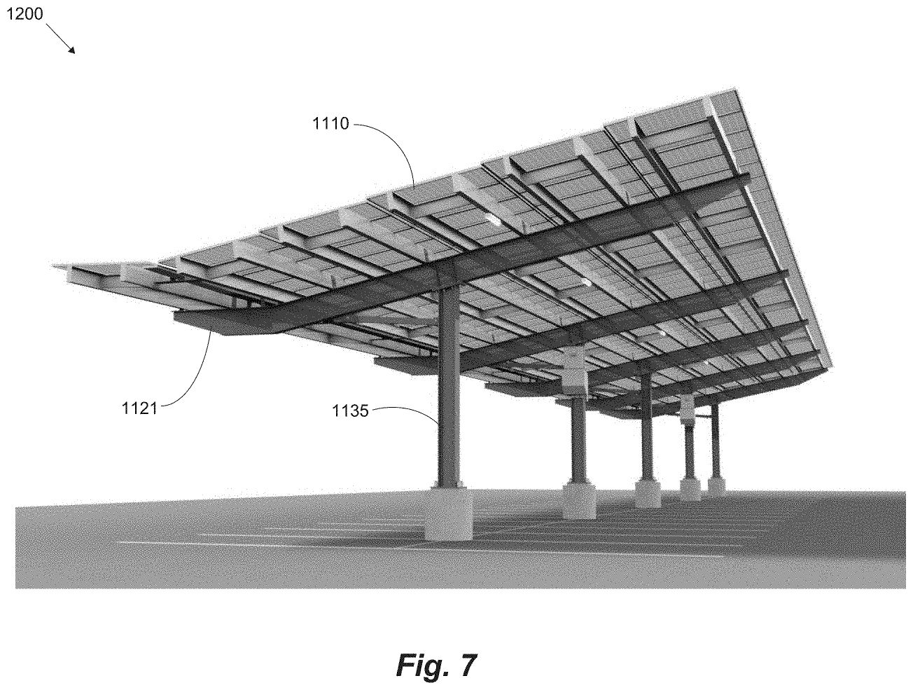

FIGS. 6 and 7 illustrate perspective views of solar carports according to aspects of the present disclosure. Unless otherwise specified below, the numerical indicators used to refer to components in the FIGS. 6 and 7 are similar to those used to refer to components or features in FIGS. 1 and 2 above, except that the index has been incremented by 1000.

FIG. 6 illustrates a perspective view of a carport 1100 according to aspects of the present disclosure. The carport in FIG. 6 includes straight crossbeams that are mounted on columns and piers. As can be seen from the figure, the PV modules are disposed on purlins that are attached to the crossbeams by clip angle brackets of various lengths to allow shingling of the PV modules. The clip angle brackets for the lowest PV modules have a greater difference in lengths in order to form a dual-incline structure by angling the lowest PV modules at an angle contrary to the angle of the other PV modules that are higher up on the crossbeam. As can be appreciated the angles of the lowest PV modules, the other PV modules, and that of the crossbeam itself are not limiting upon the present disclosure.

FIG. 7 illustrates a perspective view of a carport 400 according to exemplary aspects of the present disclosure. As can be seen from this figure, the crossbeam is formed of two sections having different, contrary angles. Thus, the crossbeam itself imparts a dual-incline structure to the carport. The PV modules are disposed on the crossbeam via purlins, which are held by clip angle brackets that vary in length in order to allow shingling of the PV modules. As can be appreciated, the dual-incline structure illustrated in FIG. 7 is merely exemplary, and other dual-incline structures are possible. For example, instead of one row, two rows of PV modules may be inclined at a contrary angle to the other rows of PV modules.

The carport 100 includes several advantages include various water management features include shingled PV modules and a dual tilt configuration using a single slope crossbeam. Additionally, the carport 100 significantly reduces cost and makes installation significantly easier. For example, other carports may require either metal decking attached to either the underside or topside of the purlins or a system of additional gutters (e.g., mini gutters) and downspouts to manage the water accumulation that falls on the canopy. Both of these strategies are costly from both a material and installation standpoint. Additionally, other carports rely on the steel fabrication of the crossbeams to create the dual tilt functionality of the canopy. This is also costly from a material and fabrication standpoint. In contrast, the advantages of carport 100 can utilize a simple single slope crossbeam which is cost effective, and then achieve the shingled method and dual tilt functionality by adjusting the clip angle brackets on top of the crossbeam.

Having now described embodiments of the disclosed subject matter, it should be apparent to those skilled in the art that the foregoing is merely illustrative and not limiting, having been presented by way of example only. Thus, although particular configurations have been discussed herein, other configurations can also be employed. Numerous modifications and other embodiments (e.g., combinations, rearrangements, etc.) are enabled by the present disclosure and are within the scope of one of ordinary skill in the art and are contemplated as falling within the scope of the disclosed subject matter and any equivalents thereto. Features of the disclosed embodiments can be combined, rearranged, omitted, etc., within the scope of the invention to produce additional embodiments. Furthermore, certain features may sometimes be used to advantage without a corresponding use of other features. Accordingly, Applicant(s) intend(s) to embrace all such alternatives, modifications, equivalents, and variations that are within the spirit and scope of the disclosed subject matter.

1. A solar assembly, comprising:
a single-slope crossbeam;
a plurality of clip angle brackets;
a plurality of photovoltaic (PV) modules, each PV module being supported by at least two of the plurality of clip angle brackets.

2. The solar assembly of claim 1, wherein the plurality of clip angle brackets are configured to create a single tilt structure supporting a plurality of shingled PV modules, and wherein the shingled PV modules are configured to direct precipitation toward a gutter.

3. The solar assembly of claim 1, wherein the plurality of clip angle brackets are configured to create a dual tilt structure.

4. The solar assembly of claim 3, wherein a first slope of the dual tilt structure includes a predetermined number of shingled PV modules, the shingled PV modules being configured to direct precipitation toward a gutter separating the first slope of the dual tilt structure with a second slope of the dual tilt structure.

5. The solar assembly of claim 4, wherein the second slope of the dual tilt structure includes a predetermined number of PV modules tilted at an angle configured to face the first slope of the dual tilt structure.

6. The solar assembly of claim 5, wherein the predetermined number of PV modules of the second slope are shingled when there is more than one PV module in the second slope.

7. The solar assembly of claim 3, wherein the plurality of clip angle brackets have different heights in order to create the dual tilt structure.

8. The solar assembly of claim 7, wherein downhill clip angle brackets are higher than uphill clip angle brackets.

9. The solar assembly of claim 1, further comprising a plurality of purlins configured to support the plurality of PV modules, the plurality of purlins being attached to the single-slope crossbeam via the plurality of clip angle brackets.

10. A solar assembly, comprising:
a support structure;
a plurality of solar modules, each solar module being supported by the support structure; and
a plurality of clip angle brackets configured to attach the plurality of solar modules to the support structure, wherein
the plurality of clip angle brackets are further configured to create an overlap between a first solar module and a second solar module, the second solar module being adjacent to the first solar module.

11. The solar assembly according to claim 10, further comprising a drip edge disposed on the first solar module and configured to prevent precipitation from entering a gap between the first solar module and the second solar module.

12. The solar assembly according to claim 11, wherein the drip edge is integrally formed on the first solar module.

13. The solar assembly according to claim 10, further comprising a flashing disposed on the first solar module and configured to prevent precipitation from entering a gap between the first solar module and the second solar module.

14. The solar assembly according to claim 13, wherein the flashing further attaches to the second solar module.

15. The solar assembly according to claim 14, wherein the flashing is flexible.

16. The solar assembly according to claim 10, further comprising a gutter disposed between two rows of solar modules and configured to guide precipitation received to an end thereof.

17. The solar assembly according to claim 16, further comprising at least one downspout configured to guide the precipitation from the gutter to a ground surface.

18. The solar assembly according to claim 16, wherein the two rows of solar modules are angled towards the gutter.

19. The solar assembly according to claim 10, further comprising gaskets configured to fill gaps between abutting PV module ends that do not overlap.

20. The solar assembly according to claim 10, wherein the support structure includes a dual-tilt support beam.
